(19) United States
(12) Patent Application Publication
(10) Pub. No.: US 2013/0194977 A1
(43) Pub. Date: Aug. 1, 2013

(54) Broadband System and Method

(71) Applicant: Karim Lakhani, Burnaby (CA)

(72) Inventor: Karim Lakhani, Burnaby (CA)

(21) Appl. No.: 13/750,987

(22) Filed: Jan. 25, 2013

Related U.S. Application Data
(60) Provisional application No. 61/592,542, filed on Jan. 30, 2012.

(51) Int. Cl. H04L 5/14

(52) U.S. Cl. CPC H04L 5/143
USPC 370/277; 375/259; 375/222

(57) ABSTRACT

A full duplex, broadband system for sparsely populated areas operating in the licensed VHF and UHF range of the electromagnetic spectrum provides service over an area of thousands of square kilometers from the base station.

### RELATED APPLICATIONS

Applicant claims the priority benefit of provisional application No. 61/592,542 filed on Jan. 30, 2012, incorporated in full by reference.

### FIELD OF THE INVENTION

The present invention relates to systems for providing broadband services using the licensed UHF band portion of the electromagnetic spectrum.

### BACKGROUND

Broadband services are ubiquitous. The supplying of such services usually rely on setting up towers, transmitting at low power, and at a high frequency range of over 900 MHz and operating in unlicensed frequencies

Recently, systems employing the 90-860 MHz range and operating in licensed frequencies have been deployed in Canada to service rural and remote communities. Such systems also require a tower. But the system allows for higher power which results in coverage of 2,000 to 3,000 or more, square kilometers (and provides high downstream data rates throughout the coverage area) compared to the 75-100 square kilometers covered by systems using higher frequencies and lower power levels.

Systems using the 90-860 MHz frequency range presently are comprised of a broadband antenna on the tower and a low loss cable from the antenna to a duplexer, a down-converter, a power amplifier and a cable modem termination system (CMTS) all located in an enclosure at the foot of the tower. The down-converter resides in the downlink; the power amplifier resides in the uplink. A computer server is located in the enclosure for controlling the system and the typical housekeeping and handshake issues. The duplexer needs to provide over 120 dB of separation between the frequencies in the downlink and uplink and costs about $1,200. An omni-directional pattern is created by using a co-linear antenna or by combining multiple directional sectorial broadband antennas to give any desired pattern with a gain of about 8 dB at a cost of $7,800. The low loss cable connecting the antenna to the duplexer is typically 200 feet long and costs around $1,500. The power amplifier costs about $7,800.

FIG. 1 is a block diagram of such a prior art system presently in operation in a number of communities in Canada and Alaska. The system comprises a single omni-directional sectorial broadband antenna TR (transmit/receive) on a tower with uplink (cable) 13 and downlink 14 connected between the antenna (via duplexer 12) and a server 16 in an enclosure at the base of the tower. Internet and telephone signals are processed via server 16 as indicated in FIG. 1.

The downlink 14 comprises a down-converter 19 and is connected to server 16 via a cable modem termination system (CMTS) 20 as indicated in the figure. The uplink comprises a power amplifier 21 (which is connected to antenna TR. via duplexer 12) and CMTS 20 (including an up converter), which connects to server 16 as is also indicated in the FIG.

Importantly, all system active components are housed in an enclosure at the base of the tower along with a power supply not shown as indicted by broken line 22.

The system of FIG. 1 uses two separate frequencies that are spaced apart as close as 24 MHz and which operate simultaneously. The transmit signal level could be as high as +93 dBmV into the duplexer and the receive signal level could be as small as −35 dBmV. With such a huge difference between the two signals, the duplexer (12) has to be able to provide a separation of over 120 dB to enable the low receive signal to be satisfactorily decoded. The duplexer is necessarily tunable over the entire band (90-860 MHz) to be shared with digital television broadcasting. The signal to noise ratios of receive signals has to be such as to enable reception of at least QAM 64 signals in the uplink (downstream) direction with signal to noise ratio of greater than 25 dB and handle QAM16 signals with at least a signal to noise ratio of greater than 18 dB in the downlink (upstream) direction.

The system of FIG. 1 operates as follows:

Server 16 outputs the data to the CMTS 20 via Ethernet cables. The CMTS creates a QAM 64 (could also be QAM 128 or QAM 256) modulated signal. The modulated signal is then up converted to the correct downstream channel frequency (example centered on 743 MHz). This is a 6 MHz wide signal from 740-746 MHz. The 743 MHz signal goes into Power Amplifier 21. From there it is fed into duplexer 12 transmit input. The duplexer ensures that all signals outside the desired range are filtered out. The output of the duplexer is fed into cable 11 (uplink) that is connected to Transmit/Receive Antenna TR. The downstream signal is radiated from the Antenna to client receivers.

The same antenna (TR) also receives the client transmitter signals. The received signal travels down cable 11 to duplexer 12. The receive signal is present on the duplexer 12 receive signal side only. The duplexer ensures that the transmit signal is not present on the receive side of the duplexer. The duplexer receive signal side is connected to down-converter 19. The receive signal in the UHF band (470 to 860 MHz) is down converted to 5-60 MHz and fed into the CMTS. The CMTS decodes the signal and provides it to server 16 via the Ethernet connection between the two devices.

The following is a list of commercial components suitable for use in the prior art system of FIG. 1.

Antenna 11—Power antenna model SVP600-360 RRBS Base Station OMNI Panel Antenna

Duplexer 12—Com-Tech Model MX5C

Server 16—HP PROLIANT DL-380 Server

Down-converter 19—Vecima Model MSDC 1000 series

CMTS 20—Arris C3 CMTS

Power Amplifier 21—Technalogix TAUD-40

### SUMMARY

In accordance with the present invention, a full duplex system, also operating in the 90 -860 MHz range, provides significantly improved signal strength, greater range and reduced costs. The invention is based on the recognition that, by splitting the system and by connecting the down and uplink paths to separate, dedicated, narrow band antennas, the duplexer is no longer needed and is replaced with two low cost narrow band filters. The downlink (upstream) filter illustratively has a minimum power rating (i.e. less than 1 watt). The receive cable can be a low cost coaxial cable with attenuation of greater than about 3 dB/100 ft and its loss characteristic has no bearing on receive signal to noise ratio. The cost of the system is reduced by over 30% and the performance of the receive signal is improved by more than 8 dB which allows for a significant improvement in range. It is considered that receive cable attenuation up to about 5 dB/100 ft would allow still lower cost cable and unaffected performance. Therefore, an attenuation range from about 3 dB/100 ft to 5 dB/100 ft is considered to provide the benefits of the reduced cost of cable without impact on performance. Moreover attenuation greater than about 5 dB/100 ft is considered acceptable while an upper limit such as over 15 dB/100 ft may be encountered if s/n degradation prevents delivery of acceptable service. The use of two relatively low cost narrow band antennas instead of one broadband antenna also allows for a significant reduction in cost. The use of two spaced-apart antennas also allows for significant advantage by locating system active components on the tower near the antennas rather than in an enclosure at the tower base. The narrow band transmit antenna (such as Kenbotong Model TQJ-600.011) ensures, that there is only limited spurious noise received in the narrow band receive antenna (also Kenbotong Model TQJ-600II). Using spaced apart narrow band antennas for transmit and for receive, located in the null pattern of each other, ensures that the receive antenna receives only a very limited amount of the transmit signal and there is minimal interference from the transmit signal entering the receive antenna.

### BRIEF DESCRIPTION OF THE DRAWINGS

FIG. 1 is a block diagram of a prior art, full duplex, rural broadband system;

FIGS. 2-4 are block diagrams of a full duplex, rural broadband system showing the locations of system components in accordance with the principles of this invention.

FIGS. 5a and 5b show the overlap and non-overlap of frequencies in the antenna passband.

### DETAILED DESCRIPTION

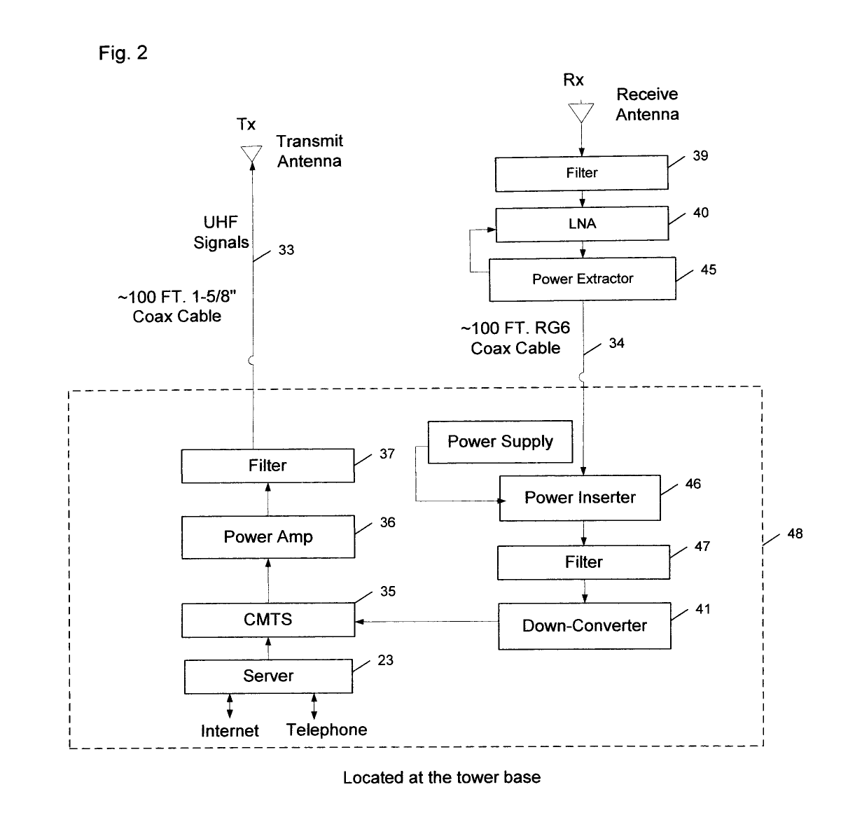

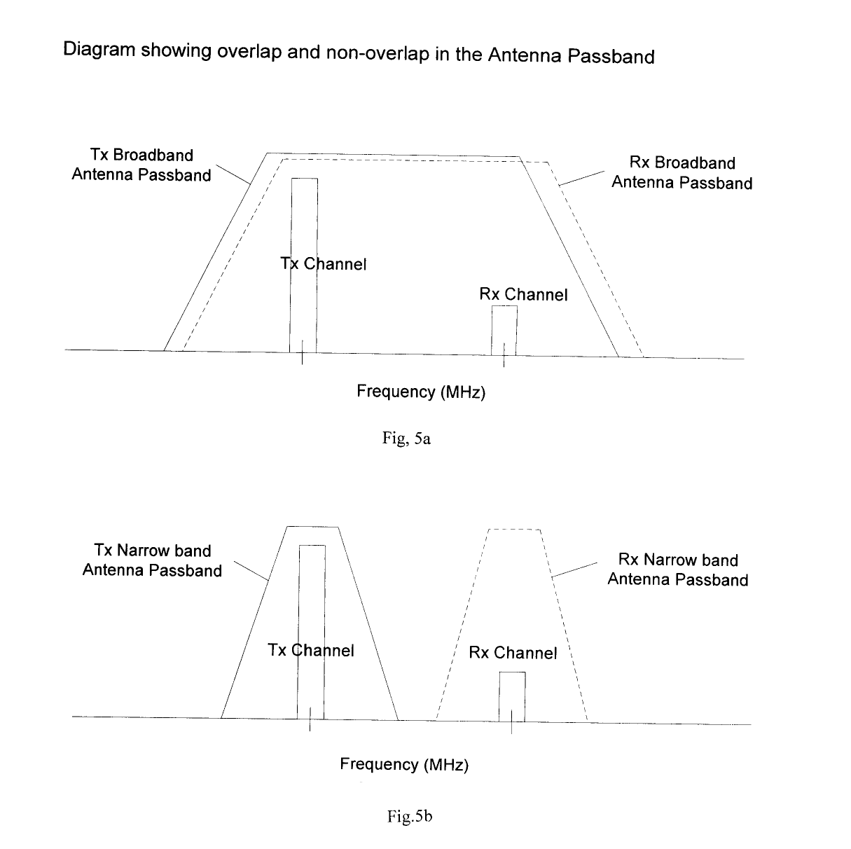

The embodiments of FIGS. 2, 3 and 4 illustrate systems, in accordance with the present invention, employing spaced-apart narrow band transmit and receive antennas connected to a server in an enclosure at the base of the tower, defining an uplink and a downlink there between respectively. The sequence of figures illustrates the location of active system components on the tower rather than in the enclosure at the base of the tower. In this context, narrow band is used to the describe the condition whereby the passband of one or both antennas is such that they do not overlap, and thus there is a high rejection of signal from one antenna to the other. FIGS. 5a and 5b show the overlap and non-overlap in the antenna passband.

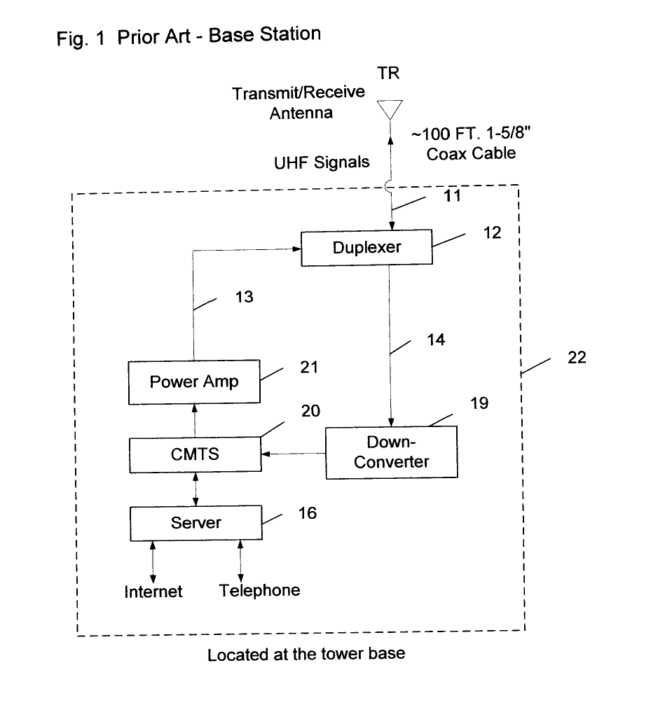

FIG. 2 illustrates the use of two narrow band, transmit and receive antennas designated Tx and Rx, respectively, rather than the single broadband antenna TR employed in the prior art system of FIG. 1. With specific reference to FIG. 2, spaced apart transmit antenna Tx and receive antenna Rx, on a tower (not shown) are connected to a server 23 defining an uplink 33 and a downlink 34 there between respectively. The uplink, in this embodiment comprises CMTS 35 and power amp 36 as is the case in the prior art system of FIG. 1. Filter 37 is added as will become clear hereinafter.

Downlink 34 includes a filter 39, low noise amplifier 40 and down-converter 41. An additional filter 47 is added to remove any spurious ingress picked up in cable 34. The CMTS also is in the downlink. The downlink includes a power extractor 45 located on the tower near antenna Rx and is connected via a coaxial cable to a power inserter 46 located in the enclosure at the tower base. The enclosure is indicated by broken line 48 in the figure. The two antennas typically are located one above the other on the tower separated by several feet. If side mounted, the antennas are typically secured at least several wavelengths from the tower.

The filter 39 and low noise amplifier (LNA) 40 (such as AI.NOO60-33.006 low noise RF amplifier 500-700 MHz, 30 dB gain, 0.6 dB NF, 12 VDC Power, SMA female connectors) are located at the base of the receive antenna. The use of two narrow band antennas and the location of the filter and LNA at the Rx antenna provide such a significant increase in gain that it allowed the use of a significantly smaller cable at much lower cost.

Filters 37 and 39 (in the uplink and in the downlink respectively) need to be 6 MHz band pass filters with different center frequencies. The center frequencies typically are at least 24 MHz apart, illustratively 743 and 713 MHz. The power extractor and power inserter illustrate one method of providing DC power to the low noise amplifier up on the tower.

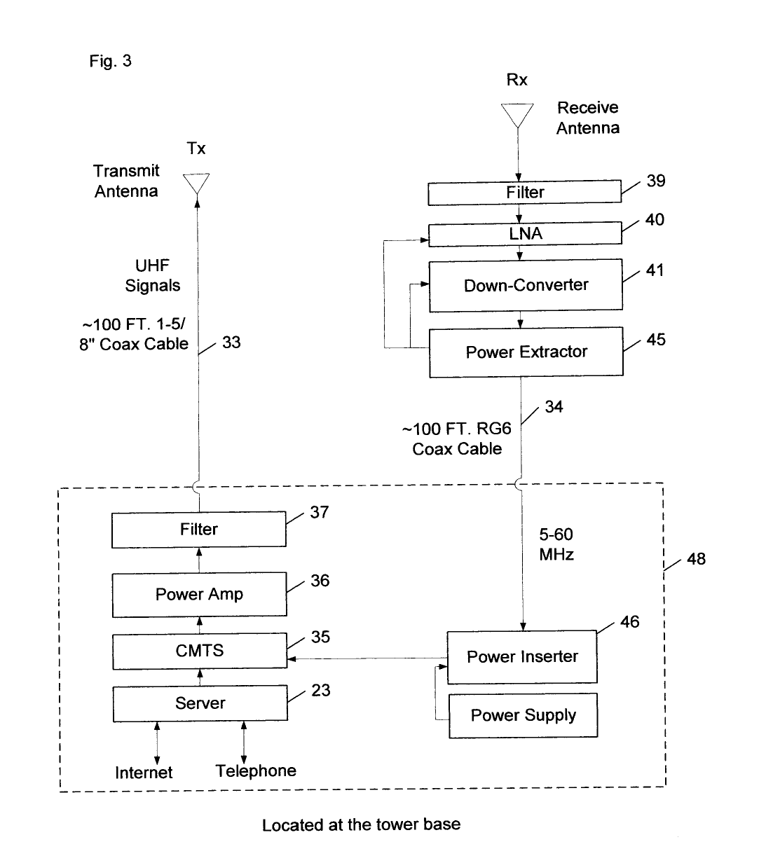

FIG. 3 illustrates a modification of the system of FIG. 2 where the down-convertor is moved from the enclosure at the base of the tower to near antenna Rx. This relocation of the down-converter allows the use of a low cost receiving cable because it now carries signals in the 5-60 MHz range and not signals in the VHF-UHF frequency range and has much lower signal loss in the cable.

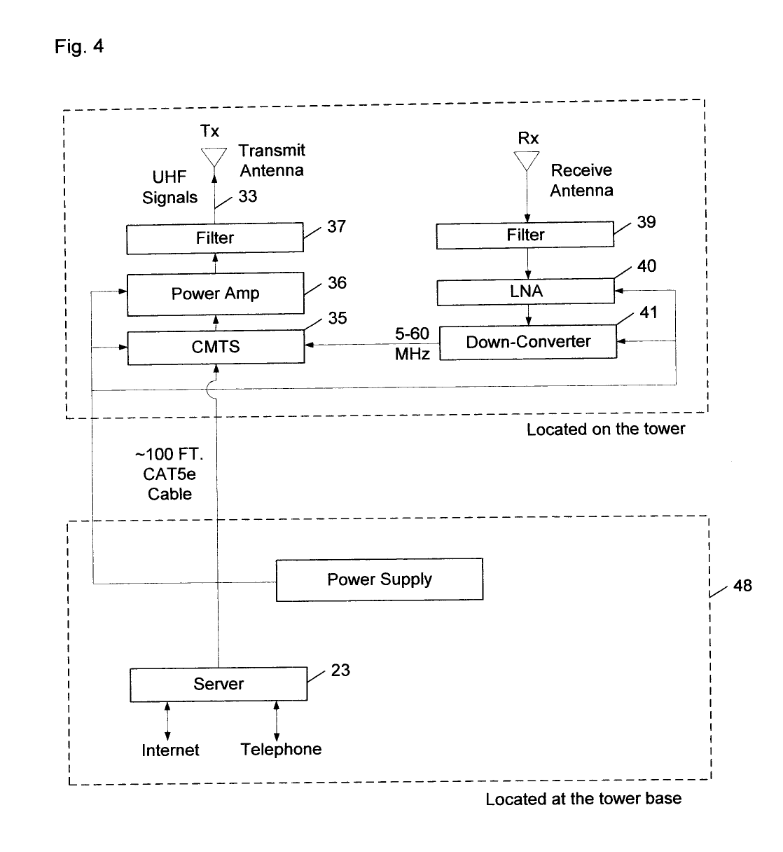

FIG. 4 illustrates the system, in accordance with the principles of this invention in which the CMTS (35) the power amplifier (PA) 36 and filter 37 are mounted on the tower near the base of the antenna TX. In this embodiment, all active components (except server 23) are located near the respective antennas on the tower.

In the operation of the system of FIG. 4, server 23 (located at the base of the tower) sends data via a Cat5e cable to the (outdoor) CMTS 35 located next to the transmit antenna. The CMTS creates a modulated QAM signal that is up-converted to the correct transmit frequency (i.e. 740-746 MHz). The signal is then fed into the (outdoor) power amplifier 36 also located close to the transmit antenna. There is a short cable from the power amplifier that is connected to the Filter 37 that eliminates signal outside the transmit band. The filter output is connected directly to the transmit antenna. The loss of signal in the Cat5e cable is low. Cable 13 is expensive and losses (i.e. −3db) in the cable required the use of a bigger power amplifier than was otherwise needed.

The receive signal is received in receive antenna Rx. There is no physical connection between the transmit antenna and the receive antenna. The receive signal is fed into a filter (39) close to the receive antenna. The filter eliminates all signal outside the receive band. Not having the high power transmit signal electrically connected to the receive antenna ensures that there is little transmit signal on the output of the receive filter. The output of the receive filter is then fed into a low noise amplifier (LNA) 40. The output of the LNA goes into down-converter 41 that converts the UHF frequency band (470-860 MHz) into the 5-60 MHz band that is fed into the CMTS.

Like numbers are used in FIGS. 2, 3 and 4 to simplify a comparison between the figures in viewing the relocation of active components from the tower base to the antennas.

The location of active components on a tower is antithetical to industry practice because of difficulty of servicing the equipment, the necessity of supplying power to the components, and the increased exposure to the elements increasing the necessity for servicing. In spite of such disincentive, active components have been located on a tower only in high frequency applications (over 900 MHz) and employing a single broadband antenna where loss of signal in the cables is a huge disadvantage. But that loss diminishes with lower frequencies and higher quality cable and is negligible at the frequency range herein.

Split systems also have been employed in the prior art. But such systems use broadband antennas and do not use narrow band antennas, which are required in accordance with the principles of this invention.

Table 1 is a cable attenuation chart showing approximate attenuation in dB for 100 feet of cable and includes the specification and costs for 1 ⅝″ coax cable (Heliax) used in the prior art system of FIG. 1 and the RG6 cable of FIG. 3 and the CAT5e cable of FIG. 4.

Cable Attenuation Chart
Approximate Attenuation in dB for 100 feet of cable

| | | Diam- | 60 | 500 | 700 | 900 | 2.4 | 5.8 | Approx. |
|---|---|---|---|---|---|---|---|---|---|
| # | Cable | eter | MHz | MHz | MHz | MHz | GHz | GHz | Cost |
| 1 | RG-59 | 0.195″ | 1.9 | 5.5 | 6.6 | 7.7 | 13.1 | 18.0 | $15.00 |
| 2 | RG-6 | 0.220″ | 1.55 | 4.51 | 5.6 | 6.2 | 10.45 | | $20.00 |
| 3 | LDF-5 | 0.875″ | | 0.87 | 1.03 | 1.60 | 2.08 | 3.65 | $750.00 |
| 4 | Heliax | 1.625″ | | 0.47 | 0.56 | 0.65 | 1.14 | 2.50 | $1,500.00 |

An embodiment of the invention is based on the realization that by using two narrow band filters and antennas and by placing active components on the tower rather than in an enclosure at the tower base is surprisingly beneficial. The benefits are realized in spite of over 10 dB loss in signal strength due to use of the high loss, low cost cable (such as RG6 or similar cable) to the components, the exposure to the elements, the limited access and the necessity and expense of supplying power to the components. The benefit is due to the fact that by amplifying the receiving signal at the antenna, the signal to noise ratio is captured at its best and the signal strength is so significantly increased that any noise picked up by the unbalanced co-axial cable becomes negligible in comparison. The additional benefits are provided by using the narrow band antenna, which provides higher gain than a comparable size broadband antenna and rejects signals outside the narrow band thereby providing a much cleaner signal into the filter at the base of the Rx antenna. The Rx antenna receive band operates to exclude the Tx signal band to ensure that it provides as much isolation from the Tx signal as possible.

### SUMMARY OF CHANGES IN THE TECHNOLOGY AND BENEFITS

1) Replace the broadband antenna with two narrow band antennas. The first benefit is that an at least 2 dB improvement in gain due to the narrow band antenna having a higher gain than is available with a broadband antenna. The second benefit is that the cost of a narrow band antenna is much less (i.e.20% of the cost of broadband omni antenna or 2% of the cost of sectorial antenna. Overall cost reduction of over 60%. The third benefit is that the narrow band receive antenna has a much better signal to noise ratio than a corresponding broadband antenna (i.e. 2 dB improvement) due to the narrow band antenna rejecting all out-of-band signals.

2) Removing the duplexer and using two antennas and moving the filter and low noise amplifier (FIG. 2) to the top of the tower gives the following benefits:
a) Much higher signal input into the filter and low noise amplifier since the loss of signal that would have been experienced in the down-cable is now gone (i.e. 0.5 to 1 dB improvement due to loss in the cable and 1 dB improvement due to initial threshold signal level of low noise amplifier being reached earlier.)
b) Much less interference signal from the transmit antenna signal into the receive antenna occurs since the transmit signal is attenuated by both the filter and the out-of-band rejection of the receive antenna, and by placement of the antennas in the null of each other's radiation pattern, thus adding much less noise to the receive signal. Overall, there is a 3 dB improvement in the signal to noise ratio.
c) Use of a very low cost cable to transport the signal from the top of the tower to the bottom since the signal to noise ratio is already capped at the top and losses in the cable will not change the signal to noise ratio appreciably due to the length of the cable. The cost of low loss, high quality cable is $1,500 while the cost of the high loss cable is $20. In addition, each connector on the larger, high quality cable is $147 per connector, whereas each connector for the smaller, high loss cable is $0.50 per connector. This is a huge cost saving. The high signal loss in the low cost cable does not in any way affect receive signal to noise ratio. The loss in the cable is compensated by using a higher gain low noise amplifier. The cost of the low noise amplifier is the same regardless of the gain of the amplifier. A low noise amplifier is used with a very low noise figure to get the best signal to noise ratio possible.
d) Cost of two filters is more than 50% less than the duplexer cost since the individual filters do not have to meet the higher specifications demanded for the duplexer. The power rating of the receive filter can now be much lower since there is no high power signal entering the filter as was the case with the duplexer. The duplexer has to have an attenuation characteristic which remains high and stays high for a huge segment of the out-of-band spectrum whereas the filter can have out-of-band attenuation characteristics that are more relaxed since the level of the transmit signal entering the receive filter is already low. Overall, much lower cost filters and lower specification filters can be utilized and still have the same benefits.

Total signal quality benefit is 2 dB from the higher gain antenna, +1 dB due to no loss in the cable, +1.5 dB (due to the higher input signal into the LNA and it is working earlier), +3 dB (due to the reduction in noise since the duplexer could not reduce the Tx signal as well), +0.7 dB improvement due to the additional filter after the LNA and cable, according to the above. In field trials there is about 10 dB improvement, which is higher than 8 dB computed above.

The embodiments described herein are merely illustrative of the principles of this invention. It should be apparent to those skilled in the art that various modifications, adaptations and alternatives may be made within the spirit and scope of the invention as claimed. For example, although the server herein is shown as located in an enclosure at the base of the tower, as it becomes practical to integrate the server, it too can be located on the tower. Also, the cable modem termination system (CMTS) although shown, illustratively, in the uplink and located near the transmit antenna, could also be located near the receive antenna. The CMTS is located near the transmit antenna to be close to the power amplifier.

1. A full duplex broadband system operative in the UHF spectrum in the absence of a duplexer comprising a narrow band transmit antenna and narrow band receive antenna spaced apart on a tower and a server in an enclosure at the base of the tower defining an uplink and a downlink there between respectively, said system comprising first and second band pass filters located at said receive and transmit antenna respectively, said downlink comprising a low noise amplifier said first band pass filter located on the tower near said receive antenna.

2. A system as in claim 1 wherein said downlink also includes a down converter located on the tower near said receive antenna.

3. A system as in claim 1 wherein said downlink also includes an additional filter located in the enclosure at the base of the tower.

4. A system as in claim 1 wherein said downlink is connected to said server via a cable modem termination system (CMTS), said broadband system comprising a power extractor and a power inserter for providing DC power to said low noise amplifier.

5. A system as in claim 2 wherein said downlink is connected to said server via a cable modem termination system (CMTS), said broadband system comprising a power extractor and a power inserter for providing DC power to said down-converter and said low noise amplifier.

6. A system as in claim 4 wherein said uplink comprises said second band pass filter, a power amplifier and said CMTS all located on said tower near said transmit antenna.

7. A system as in claim 5 wherein said uplink comprises said second band pass filter, a power amplifier and said CMTS all located on said tower near said transmit antenna.

8. A system as in claim 1 wherein said transmit and receive antennas are spaced apart in a linear arrangement, which if side mounted, are each at least several wavelengths from the tower.

9. A system for providing full duplex broadband services employing spectrum in the 90-860 MHz range comprising a narrow band receive antenna and a narrow band transmit antenna in split apart positions on a tower, said antennas being connected to a server and defining a downlink and an uplink there between respectively, the active components of said uplink comprising said second band pass filter, a power amplifier and said CMTS all the active components of said downlink and said uplink being located on the tower near said receive antenna and said transmit antenna respectively.

10. A system for providing full duplex broadband services employing spectrum in the UHF band, said system comprising narrow band transmit and receive antennas spaced apart from one another on a tower and defining an uplink and a downlink, respectively with a server, said uplink comprising a first narrow band filter, a power amplifier and a cable modem termination system located on said tower near said transmit antenna, said downlink comprising a second narrow band filter, a low noise amplifier a down-converter located on said tower near said receive antenna, said receive and transmit antennas being connected to said server via said cable modem termination system located near said transmit antenna.

11. A system for providing full duplex services in the 90-860 MHz range comprising: a narrow band receive antenna and a narrow band transmit antenna in spaced apart positions on a tower, said antennas being energy coupled to a server defining a down link and an up link therebetween respectively, said down link comprising active components operative to receive signals in the 90-860 MHz range, filter out signals outside the receive frequency, amplify the receive signals and down convert the receive signals to the 5-60 MHz band, said up link comprising active components operative to create modulated QAM signal, up convert the signal to a transmit signal in the 90-860 MHz range and amplify the signal for transmission.

12. A system for providing full duplex services employing spectrum in the 90-860 MHz range comprising a narrow band receive antenna and a narrow band transmit antenna in spaced apart positions on a tower, said antennas being energy coupled to a server and defining a down link and an up link therebetween respectively, said up link including active components operative to create a base band signals and up convert the signals to a transmit signal frequency in the 90-860 MHz range, said down link including active components operative to receive signals in the 90-860 MHz band to filter out transmit signal frequencies, amplify the receive signal and down convert the receive signal into the 5-60 MHz band, said active components of said up link and said downlink being located near said transmit and receive antennas respectively.

13. A system as in claim 12 comprising a cable modem termination system (CMTS) for creating said 90-860 MHz band signal, and receiving the 5-60 MHz receive signal being input to said CMTS.

14. A system as in claim 13 herein said CMTS also is located near said transmit antenna.

15. A method for digital communication in the ultra-high frequency (UHF) spectrum comprising:
transmitting modulated digital output information from a narrow band transmit antenna, wherein the modulated digital output information is transmitted within a first frequency band in the UHF spectrum, and
receiving modulated digital input information from a narrowband receive antenna, wherein the modulated digital input information is received within a second frequency band in the UHF spectrum, wherein the second frequency band does not overlap the first frequency band, and wherein the narrow band transmit antenna is spaced apart from the narrow band receive antenna, and
wherein transmitting modulated digital output information comprises steps of:
receiving digital output information;
modulating the digital output data information in a first modulation format to provide a modulated digital output signal containing modulated digital output information;
amplifying the modulated digital output signal to generate an amplified digital output signal;
filtering the amplified digital output signal to provide a filtered digital output signal with a spectrum within the first frequency band; and
transmitting the filtered digital output signal with the narrow band transmit antenna,
and wherein receiving modulated digital input information comprises steps of:
receiving a modulated digital input signal in a second modulation format with the narrow band receive antenna, wherein the modulated digital input signal contains the modulated digital input information;
filtering the modulated digital input signal to provide a filtered digital input signal with a spectrum within the second frequency band;
amplifying the filtered digital input signal to provide an amplified digital input signal;
downconverting the amplified digital input signal to provide a baseband digital input signal;
demodulating the amplified digital input signal to provide digital input information; and
outputting the digital input information.

16. The method as in claim 15 wherein the narrow band transmit antenna has an antenna pattern with one or more transmit antenna nulls and the narrow band receive antenna has an antenna pattern with one or more receive antenna nulls, and wherein the narrow band transmit antenna is positioned relative to the narrow band receive antenna within at least one receive antenna null and wherein the narrow band receive antenna is positioned relative to the narrow band transmit antenna within at least one transmit antenna null.

17. The method as in claim 15 wherein the narrow band transmit antenna has an antenna pattern with one or more transmit antenna nulls and wherein the narrow band receive antenna is positioned relative to the narrow band transmit antenna within at least one transmit antenna null.

18. The method as in claim 15 wherein the narrow band receive antenna has an antenna pattern with one or more receive antenna nulls, and wherein the narrow band transmit antenna is positioned relative to the narrow band receive antenna within at least one receive antenna null.

19. The method as in claim 15, wherein tower equipment located on a tower performs the steps of receiving the modulated digital input signal, filtering the modulated digital input signal, and amplifying the filtered digital input signal, and off-tower equipment performs the steps of downconverting the amplified digital input signal, demodulating the amplified digital input signal, and outputting the digital input information, and wherein the filtered digital input signal is coupled from the tower equipment to the off-tower equipment with a cable having an attenuation greater than about 5 dB per 100 feet of cable within the second frequency band.

20. The method as in claim 19, further comprising:
inserting power into the cable within the off-tower equipment; and
extracting power from the cable within the tower equipment.

21. The method as in claim 19, further comprising filtering the amplified digital input signal prior to downconverting.

22. The method as in claim 15, wherein tower equipment located on a tower performs the steps of receiving the modulated digital input signal, filtering the modulated digital input signal, amplifying the filtered digital input signal, and downconverting the amplified digital input signal and off-tower equipment performs the steps of demodulating the amplified digital input signal and outputting the digital input information, and wherein the filtered digital input signal is coupled from the tower equipment to the off-tower equipment with a cable having an attenuation greater than 5 dB per 100 feet of cable at a frequency band defined by the baseband digital input signal.

23. The method as in claim 22, further comprising:
inserting power into the cable within the off-tower equipment; and
extracting power from the cable within the tower equipment.

24. The method according to claim 15, wherein tower equipment located on a tower performs the steps of receiving the modulated digital input signal, filtering the modulated digital input signal, amplifying the filtered digital input signal, downconverting the amplified digital input signal demodulating the amplified digital input signal, outputting the digital input information, receiving digital output information, modulating the digital output data information, amplifying the modulated digital output signal, filtering the amplified digital output signal, and transmitting the filtered digital output signal, and wherein the digital output information is received from a digital communication cable and the digital input information is output with the digital communication cable.

25. The method according to claim 24, wherein the digital communication cable couples the tower equipment to a server.

26. The method according to claim 15, wherein the digital output information is received from a server and the digital input information is output to the server.

27. The method according to claim 15, wherein the first modulation format or the second modulation format or the first and second modulation format comprise quadrature amplitude modulation.

28. The method according to claim 15, wherein a cable modem termination system performs the steps of modulating the digital output data information and demodulating the amplified digital input signal.
